(19) United States
(12) Patent Application Publication
(10) Pub. No.: US 2003/0103765 A1
(43) Pub. Date: Jun. 5, 2003

(54) MPEG recording apparatus, recording medium and transmission method

(76) Inventors: Takayuki Sugahara, Yokosuka-shi (JP); Toshio Kuroiwa, Yokohama-shi (JP); Harukuni Kobari, Yokohama-shi (JP); Norihiko Fuchigami, Kamakura-shi (JP)

Correspondence Address: LOUIS WOO, LAW OFFICE OF LOUIS WOO, 717 NORTH FAYETTE STREET, ALEXANDRIA, VA, 22314, US

(21) Appl. No.: 10/304,957

(22) Filed: Nov. 27, 2002

(30) Foreign Application Priority Data
Nov. 30, 2001 (JP) 2001-367621

(51) Int. Cl. H04N 5/76; H04N 5/781

(52) U.S. Cl. 386/95; 386/111

(57) ABSTRACT

In a recording apparatus, data received as an MPEG-2 transport stream, for example from a digital broadcast or by playback of data in the D-VHS recording format, are converted to respective MPEG-2 program streams of one or more programs conveyed by the transport stream, with the program stream data being recorded, while in addition the program specific information and service information (PSI/SI information) which are received multiplexed within the transport stream are demultiplexed and also recorded. By ensuring that PSI/SI information relating to respective programs are recorded such as to be linked to the recorded data of the corresponding programs, it becomes possible to subsequently execute playback of the data of one or more programs and of PSI/SI information, execute program stream to transport stream conversion, and thereby transmit the program data in an MPEG-2 transport stream having appropriate PSI/SI information multiplexed therein, without requiring complex processing to be performed for enabling such program stream information to be generated and re-multiplexed into the transport stream.

### BACKGROUND OF THE INVENTION

1. Field of the Invention

The present invention relates to an MPEG-2 recording apparatus, recording medium, and transmission method.

2. Description of the Prior Art

In the prior art, Japanese patent application publication number 8-340154/1996 describes an MPEG-2 (MPEG: Moving Picture Experts Group) system having a digital data recording method, recording apparatus and playback system, i.e., for application to programs which are conveyed in an MPEG-2 transport stream. Here, the term “program” signifies in general a set of tightly related digital data streams (elementary streams), such as a video stream and one of more audio streams having a common reference timebase, constituting for example a broadcast television program, or the contents of a track of a recording disk such as a DVD (Digital Versatile Disk).

With MPEG-2, after having been compression-encoded, an elementary stream is converted to a stream of packets, referred to as a PES (Packetized Elementary Stream). A multiplexed set of such PESs, for one program, can be recorded and reproduced as a single MPEG-2 program stream, as described hereinafter. In that case, the data are generally recorded in the form of an MPEG-2 program stream, which is a set of multiplexed packetized data streams having a relatively large packet size. In addition, the contents of a plurality of such sets of PESs, for respective programs, can be conveyed as a single MPEG-2 transport stream, when the data are to be transmitted. In an MPEG-2 transport stream, in addition to packets which convey video and audio data (referred to in the following as main packets) auxiliary data (for use by a receiving apparatus for such purposes as extracting the packets conveying data of a specific desired program, etc.) are sent in respective sequences of sub packets. These sequences of sub packets are multiplexed into (i.e., inserted at periodic intervals within) the MPEG-2 transport stream.

Each main packet in an MPEG-2 transport stream includes a number (the PID, or packet identifier) which relates the packet to a specific PES, and can be used by a receiving apparatus to identify the program whose data are conveyed a payload data by that main packet. The auxiliary data include information which relates the various programs to these PIDs. Thus for example, when an MPEG-2 stream is received and demultiplexed, a user apparatus can extract, decode and thereby reproduce the original data of a desired program, by using the auxiliary data. The auxiliary data basically consist of Program Specific Information (PSI) and Service Information (SI) as described hereinafter.

With the aforementioned Japanese patent application number 8-340154/1996, the auxiliary data in the sub packets are recorded together with the MPEG-2 transport stream main packets, by a recording apparatus. As a result, when playback of the recorded data is performed, it is possible to easily decode and reproduce the main data of a desired program, from the contents of the main packets, by using the auxiliary data. This technology enables, for example, a set top box (STB) utilizing the MPEG-2 system to be provided whereby, when playback of MPEG-2 recorded data is performed and the playback data supplied to the STB, the main data can be readily decoded and reproduced from the main packets by utilizing the auxiliary data.

As another prior art example, Japanese patent application publication number 2000-261802 discloses a transmitting apparatus and method whereby MPEG-2 data read out from a DVD are converted to a modified MPEG-2 transport stream and sent over a transmission path to a receiving system. The objective of that invention is to enable such transmission to be effectively achieved irrespective of the performance capabilities (e.g., such as bandwidth of the transmission channel, data processing performance, etc.,) of the overall system. This is done for example by enabling the user to specify whether or not all of the I (Intra-coded), P (Predictive-coded), and B (Bidirectionally predictive coded) pictures of each MPEG GOP (group of pictures) read out from a DVD will be used in generating a modified MPEG-2 transport stream that will be transmitted, or whether only a part of these pictures will be selected (e.g., only the I-pictures) to be re-encoded as part of the MPEG-2 transport stream that will be transmitted. In that way, the amounts of data which are encoded as the MPEG-2 transport stream and transmitted can be modified, such as to be within the performance capabilities of the overall transmitting/receiving system. As a result, the DVD information can be transmitted and played back (viewed) irrespective of the capabilities of the actual equipment that is used to transmit and receive the information.

With prior art methods such as those described above, although it is possible to record MPEG-2 transport stream data together with the corresponding auxiliary data, the prior art does not provide any technique whereby, after a received MPEG-2 transport stream has been converted to program stream form and then recorded (so that when playback is performed, the original contents of respective programs can then be directly decoded and reproduced), the data thus recorded can also be easily converted back to an MPEG-2 transport stream having the appropriate auxiliary information multiplexed therein, and transmitted to an external apparatus. If that were possible, then the recorded data could readily be reconverted and sent to any type of apparatus which is designed to receive MPEG-2 transport stream data. Hence, a high degree of system convertibility would be achieved.

Furthermore, although means are described whereby data such as the data contents of a DVD etc., can be converted to a format whereby the data can be reproduced by an external STB (set top box) etc., the prior art does not provide any information concerning the loss of auxiliary data when such format conversion occurs, or any specific method of management relating to the auxiliary data that are lost when the conversion is performed, i.e., a method whereby such auxiliary data can be recovered.

### SUMMARY OF THE INVENTION

It is an objective of the present invention to overcome the above problems of the prior art by providing an MPEG recording apparatus, recording medium, playback apparatus and transmission apparatus, whereby system convertibility can be achieved. Specifically, in a case such as when MPEG transport stream data (e.g., received from a digital broadcast, etc.,) are converted to MPEG program stream data and then recorded on some form of recording medium (e.g., written on an optical disk, hard disk, etc., or stored in computer memory) the invention ensures that the MPEG-2 program streams can be subsequently read out from the recording medium and can converted/re-multiplexed back to a single MPEG transport stream, with all or part of the original auxiliary data which were inserted in the original MPEG-2 transport stream inserted in the newly generated transport stream. That is to say, appropriate auxiliary data relating to the program streams can be directly read out from the recording medium and multiplexed into the newly generated transport stream, without the need for the recording/playback apparatus to perform complex specialized processing to newly generate appropriate auxiliary info (i.e., program specific information, service information, etc.)

In that way MPEG-2 transport stream data which have been received, converted to program stream form and recorded, so that programs can be subsequently read out from a recording medium and the program contents reproduced (e.g., displayed to a user), can also easily be re-multiplexed and transmitted to a receiving apparatus which is designed to handle MPEG-2 transport stream data. Hence, a high degree of system convertibility can be achieved.

This is basically achieved by operating on a received MPEG-2 transport stream to not only convert it to (in general) a plurality of MPEG-2 program streams, by using the auxiliary information which are received multiplexed within the transport stream, and recording the program stream data on a recording medium, but also recording the received auxiliary information on that recording medium in such a way that portions of the auxiliary information which relate to specific programs are recorded linked to those specific programs.

More specifically, according to a first aspect, the invention provides an MPEG recording apparatus comprising means for converting an MPEG transport stream to an MPEG program stream, means for separating from the MPEG transport stream all or part of information which is constituted by at least program specific information and service information which are multiplexed with the MPEG transport stream, and means for recording on a recording medium the converted MPEG program stream and the information which are separated from the MPEG transport stream, with the separated information being recorded linked to the converted MPEG program stream.

According to a second aspect, the invention provides a recording medium having recorded thereon an MPEG program stream which has been converted from an MPEG transport stream, and separated information comprising all or part of at least program specific information and service information which are multiplexed with the MPEG transport stream. The separated information are recorded on the recording medium such as to be linked to the converted MPEG program stream.

According to a third aspect, the invention provides a playback apparatus for executing playback of a recording medium as described above, comprising means for reading out from the recording medium the MPEG program stream and at least a part of the separated information, and means for decoding the data of the MPEG program stream and combining resultant decoded data with the at least part of the separated data to produce outputted playback data.

According to a fourth aspect, the invention provides a transmission apparatus for reading out and transmitting, via a transmission path, information which has been recorded on a recording medium as described above. The apparatus comprises means for reading out from the recording medium the MPEG program stream and the information comprising all or part of the program specific information and service information, conversion means for converting the MPEG program stream read out from the recording medium to an MPEG transport stream, and means for re-multiplexing with the converted MPEG transport stream the information comprising all or part of the program specific information and service information. The resultant re-multiplexed packet stream can then be transmitted.

According to a fifth aspect, the invention provides an MPEG recording method which comprises converting an MPEG transport stream of data to an MPEG program stream of data, separating from the MPEG transport stream all or part of information which is constituted by at least program specific information and service information which are contained in the MPEG transport stream, and recording on a recording medium the converted MPEG program stream and the information which are separated from the MPEG transport stream, with the separated information being recorded linked to the converted MPEG program stream.

According to a sixth aspect, the invention provides a method of executing playback of the aforementioned recording medium, comprising reading out from the recording medium the MPEG program stream and at least a part of the separated information, and decoding the data of the MPEG program stream and combining resultant decoded data with the separated data to produce outputted playback data.

According to a seventh aspect the invention provides a method of reading out and transmitting, via a transmission path, information recorded on the aforementioned recording medium, comprising reading out from the recording medium the MPEG program stream and the information comprising all or part of the program specific information and service information, converting the MPEG program stream read out from the recording medium to an MPEG transport stream, and re-multiplexing the converted MPEG transport stream with the information comprising all or part of the program specific information and service information, to thereby obtain a re-multiplexed data stream, and transmitting the re-multiplexed data stream.

### BRIEF DESCRIPTION OF THE DRAWINGS

FIG. 1 is a block diagram of an embodiment of an MPEG recording apparatus according to the present invention;

FIG. 2 is a block diagram of an embodiment of an MPEG playback apparatus;

FIG. 3 is a block diagram of an embodiment of an MPEG transmission apparatus;

FIG. 4 is a diagram for describing an example of the file format used for library information, with the present invention;

FIG. 5 is a diagram for describing an example of a side information hierarchy of library information, used with the present invention;

FIG. 6 is a diagram for describing an example of an index format of library information, used with the present invention;

FIG. 7 is a diagram for describing a GENERAL_IFO table of side information, used with the present invention;

FIG. 8 is a diagram for describing a PROGRAM_IFO table of side information, used with the present invention;

FIG. 9 is a diagram for describing a INDEX_IFO table of side information, used with the present invention;

FIG. 10 is a diagram for describing the syntax of a PAT table;

FIG. 11 is a diagram for describing the syntax of a PMT table;

FIG. 12 is a diagram for describing the syntax of a SIT table;

FIG. 13 is a diagram showing various types of descriptor;

FIG. 14 is a block diagram of an MPEG encoder;

FIG. 15 is a block diagram of an MPEG decoder;

FIG. 16 is a block diagram of an MPEG multiplexing system;

FIG. 17 is a diagram showing the relation between an MPEG transport stream (TS), program stream (PS) and program elementary stream (PES); and

FIG. 18 is a diagram showing an example of utilizing the program-specific information (PSI) of an MPEG transport stream.

### DESCRIPTION OF PREFERRED EMBODIMENTS

Before describing embodiments of the present invention, an explanation of the MPEG video encoding method and MPEG method of multiplexing video and audio information will be provided. In the following “transport stream” and “program stream” will generally be abbreviated to TS and PS, respectively. MPEG is an abbreviation for “Moving Pictures Experts Group”, which was a working group of SC29 (a subcommittee of the Joint ISO/IEC Technical Committee) and was set up in 1988 to deal with matters concerning “Coding of Picture, Audio, Multimedia and Hypermedia”. One of the standards which it established is known as MPEG-1 (MPEG phase 1), which is a standard for media storage at a rate of approximately 1.5 Mbps, and whose basic technology was derived from the JPEG standard for still picture encoding and an H.261 standard (the CCIT SGXV standard, which is now ITU-T SG15) for compression of moving pictures from teleconferencing or video telephones at a low data rate. MPEG-1 was established in August 1993 as ISU/IEC 11172. MPEG-2 (MPEG phase 2) was established in November 1994 as ISU/IEC 13818 H.262, as a general standard which is intended for various applications relating to communications and transmission.

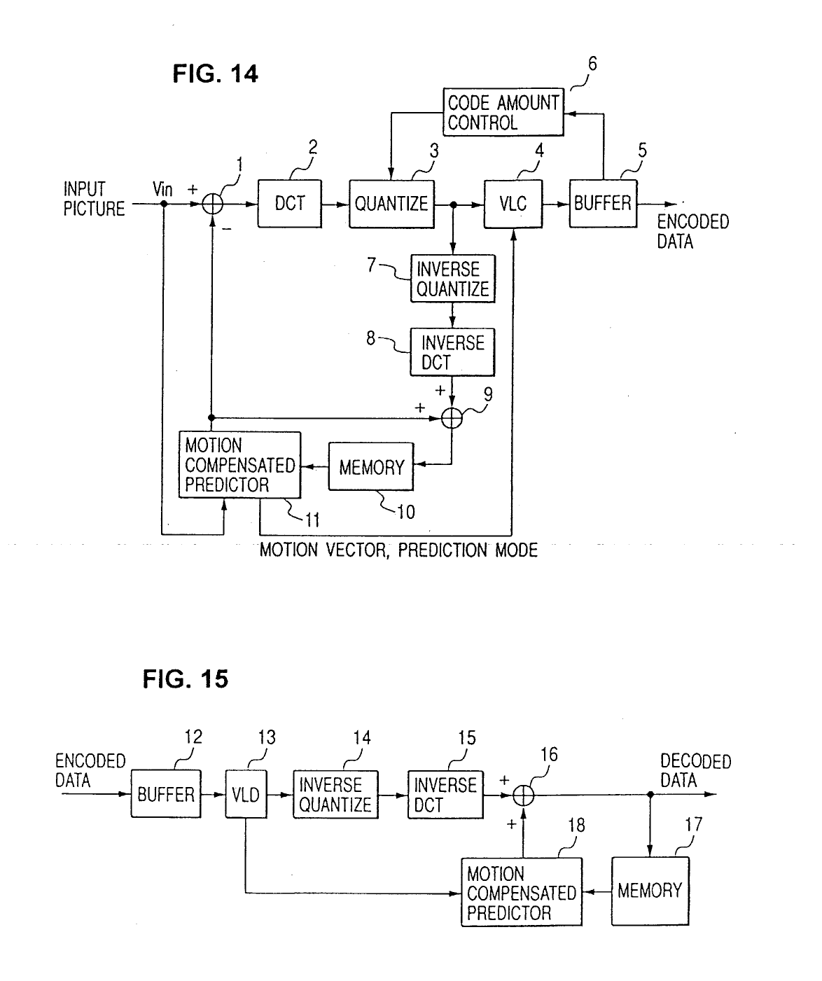

MPEG-2 is a combination of various technologies. FIG. 14 shows an MPEG compression apparatus. The operation is as follows. A digital signal expressing a picture Vin is supplied to the adder 1, and the difference between Vin and a decoded reference picture which is produced by the motion compensated predictor 11 is obtained, for the purpose of removing excess time intervals. There are three prediction modes, i.e., forward (from the past), backward (towards the past), and bidirectional. Prediction can be performed in each of 16×16 sets of pels, these sets being referred to as macroblocks. The prediction direction is determined based on the picture type that has been assigned to the input picture. One picture type is the P-picture, for which there are two possible encoding modes, i.e., prediction from the past, or encoding of the macroblocks respectively independently, with no prediction performed. Another picture type is the B-picture, for which there are four possible encoding modes, i.e., future-directed prediction, prediction from the past, bidirectional prediction, and independent encoding of the macroblocks. The third picture type is the I-picture, for which all of the macroblocks are independently encoded.

Motion compensation is performed to an accuracy of one-half pel, by performing pattern-matching of each of respective macroblocks of a region which is in motion within a picture. The prediction is performed by applying amounts of shift that correspond to amounts of motion. There are two directions of motion vector, i.e., horizontal and vertical. This vector is transmitted together with the MC (motion compensation) mode which indicates the type of prediction, as additional information of a macroblock. The set of pictures which extends from one I-picture to the picture which precedes the succeeding I-picture is referred to as a GOP (group of pictures). In the case of an application such as data storage, a GOP generally consists of approximately 15 pictures.

The DCT (discrete cosine transform) section 2 applies the discrete cosine transform operation on the data constituting a difference picture, which is derived by subtracting a reference picture from the input picture. The DCT is an orthogonal transform which converts the results of an integral transform based on the cosine function into a finite space. In the case of MPEG, each macroblock is divided into four sets of 8×8 blocks, and a two-dimensional DCT is applied to each of these sets. Generally, a video signal has relatively large amounts of low-frequency components, and small amounts of high-frequency components, so that when the DCT transform is applied, the resultant DCT coefficients will be concentrated in the low-frequency range.

The DCT-converted picture data (i.e., DCT coefficients) are then quantized by the quantizer 3. The quantizer utilizes an 8×8 2-dimensional set of frequencies referred to as a quantization matrix, which is weighted in accordance with visual characteristics. A monopoloid value is obtained, as the quantization value, by multiplying overall by a value referred to as a quantization scaler, and each of the DCT coefficients that have been obtained are divided by this quantization value. When decoding is performed in the decoder, multiplication by the quantization value is performed, to recover values which are approximately identical to the original DCT coefficients.

The quantized data are subjected to variable-length encoding by the VLC section 4. Of the quantized values, those values which express a DC component are encoded using DPCM (differential pulse code modulation) which is a type of predictive encoding. Values expressing AC components are subjected to zig-zag scanning in a direction extending from the low-frequency to the high-frequency range, with lengths of runs of all-zeros and the values of valid coefficients being registered. Hoffman encoding is then applied, to assign short lengths of code to those values which have a high incidence of occurrence. The resultant variable-length encoded data are temporarily set in the buffer 5, then are outputted at a specific transfer rate.

Values expressing the respective amounts of code that are generated for each macroblock of that output are supplied to a code amount controller 6, which applies control of the amount of generated code by applying feedback to the quantizer 3 such as to adjust the quantization scale to control the difference between the amount of generated code and a target value of generated code. The quantized picture data are also subjected to dequantization by the dequantizer 7, and inverse DCT transform is applied by the inverse DCT section 8, to recover the original DCT coefficients. These DCT coefficients are added, in the adder 9, to a reference picture which has been decoded by the motion compensation predictor 11. The picture data from the adder 9 are then temporarily set in the buffer 10, then used by the motion compensation predictor 11 as a reference decoded picture for calculating a difference picture.

FIG. 15 shows the MPEG decoder apparatus. The demultiplexed data stream is buffered, then sent from the buffer 12 to the VLD (variable length decoder) 13, to be subjected to variable-length decoding. The DC components and AC components are thereby recovered. The AC component data are subjected to zig-zag scanning in a direction extending from the low-frequency to the high-frequency range, and allocated to an 8×8 matrix. The data are then supplied to the dequantizer 14 to be subjected to dequantization using a quantization matrix. The dequantized data are then subjected to the inverse DCT operation in the inverse DCT section 15 , and the resultant DCT coefficients are added, in the adder 16, to the decoded reference picture that is obtained from the motion compensation predictor 18. The resultant image data are then outputted as the decoded picture data. The decoded data are temporarily set into the picture memory 17, and are then supplied to the motion compensation predictor 18 for use in calculating the reference decoded picture.

In the MPEG system, respective bit streams, i.e., consisting of an encoded video bit stream, encoded audio bit stream etc., are multiplexed into single bit stream. This single bit stream is produced such as to be in accordance with a standardized method of reproduction which will maintain synchronization. The system standards can be basically summarized under the following five points:

(1) synchronized reproduction of the plurality of multiplexed bit streams,

(2) multiplexing of a plurality of encoded bit streams into a single bit stream,

(3) buffer initialization when reproduction begins

(4) continuous buffer management

(5) timing standards for decoding and reproduction, etc.

In order to perform such bit stream multiplexing with the MPEG system, it is necessary to convey information in the form of packets. With one method of packet multiplexing, such as for video and audio multiplexing, i.e., PES (Program Elementary Stream) packets of an MPEG-2 PS, each of the packets in the multiplexed stream is made of appropriate length. Additional information such as headers, etc., are added, and time division transmission is performed by switching between audio and video packets. A packet header can include information for distinguishing between audio, video, etc., and timing information for synchronization purposes. The packet length depends upon the transmission medium and the application, and can extend from 53 bytes (in the case of ATM) up to as long as 4 K bytes (in the case of an optical disk). In the case of an MPEG-2 program stream, the packet length is variable, and can be arbitrarily specified.

Data may be sent as packs and packets, with one pack being formed of several packets. A pack-start-code and SCR (System Clock Reference) are provided at the head of each pack. A Stream ID and time stamp appear at the head of a PES packet. The time stamp expresses time information, for synchronization of video and audio, etc. There are two types of time stamp, i.e., a DTS (Decoding Time Stamp) and a PTS (Presentation Time Stamp). The PCR (Program Clock Reference) has a timing accuracy of 27 MHz, and constitutes information for a reference time clock of the decoder. The DTS expresses the decoding starting time point for the first access unit in the packet data. An access unit is one picture, in the case of video, and is for example 1152 samples in the case of audio. The PTS expresses the starting time point for display (i.e., reproduction/outputting of original data contents).

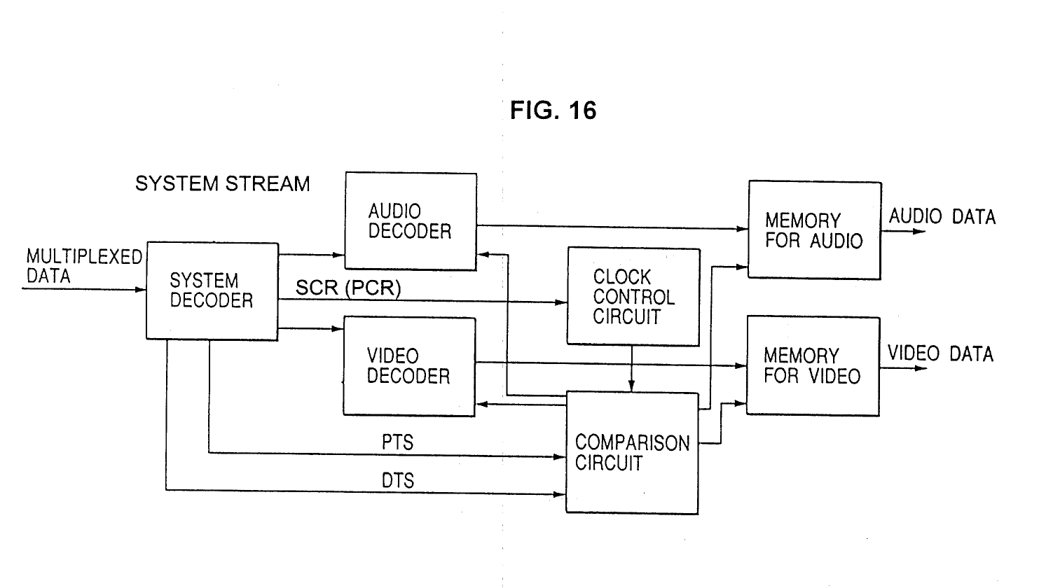

As shown in FIG. 16, a decoder for video, audio, etc., continuously monitors a common reference time, which is set to zero by the PCR. When the DTS and PTS times coincide, the decoder executes decoding and display. The multiplexed data are buffered in respective decoders. A virtual decoder for providing synchronized display is referred to as a STD (System Target Decoder). To prevent overflow or underflow, the STDs must be multiplexed.

As mentioned above, MPEG-2 data can be conveyed in the form of a TS (Transport Stream) or a PS (Program Stream). Each of these consists of one or more multiplexed PESs (Packetized Elementary Streams), which are multiplexed with packets (sub packets) which contain auxiliary information. The PES is standardized as an intermediate stream, which enables conversion between the TS and the PS streams. Generally, a PES conveys encoded video data, or encoded audio data. However it is possible for a PES to convey a packetized streams of some other form of data.

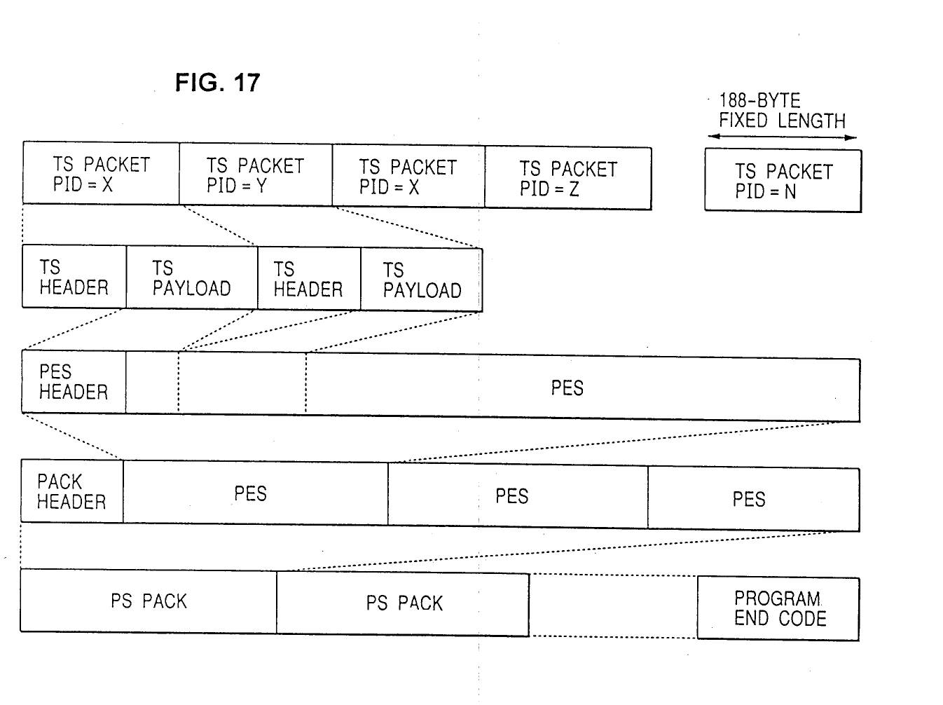

An MPEG-2 PS consists of one or more multiplexed PESs which have a common reference timebase, for example the respective PESs conveying the video and audio data of one program. Sometimes referred to as the packet layer, the PES configuration is illustrated in FIG. 17. With the standard model of MPEG-2 PS, the packets of a specific PES within that PS can be selected by utilizing the aforementioned stream IDs which are contained in the PES packets.

In the case of a TS, in the same way as described for a PS, it is possible to multiplex the video and audio of programs which have a common reference time. However with a TS, it is also possible to multiplex the respective sets of PESs of a plurality of programs which have respectively different timebases. Based on considerations of ATM cell length and error correction coding, TS packets are fixed-length packets each consisting of 188 bytes. Hence, due to the short packet length, a TS is suitable for use in an environment in which occurrence of errors is likely. The configuration of a TS packet is not complex, however when the TS is a multi-program stream, the management becomes complex. Although it is a higher-level structure, the length of a TS packet is less than that of a PES packet. That is to say, PES packet is generally divided up and inserted into a plurality of TS packets before being transmitted in a TS, so that the payload data of one PES packet may be conveyed by several TS packets.

With the standard model of a TS, stream selection can be performed (e.g., the packets for one of a plurality of programs which are conveyed by that TS can be selected) by using the PID (Packet Identifier) which is a number appearing in the header of each TS packet. FIG. 17 shows the TS packet configuration. The first part of the header is an 8-bit synchronization byte, which is followed by three flag bits, i.e., a transport error indication flag, a flag which indicates the start of a payload, and a flag which indicates transport priority. Next comes the aforementioned PID, which identifies the payload that is conveyed by the packet. That is to say, the PID identifies a specific PES stream to which the packet belongs. This is succeeded by scrambling control information (2 bits), then information for indicating whether or not an adaptation field is conveyed in the payload (2 bits), then the packet continuity counter (4 bits). These are followed by the actual payload data contents. If necessary, padding bits may be inserted. Null packets may also be inserted in the TS.

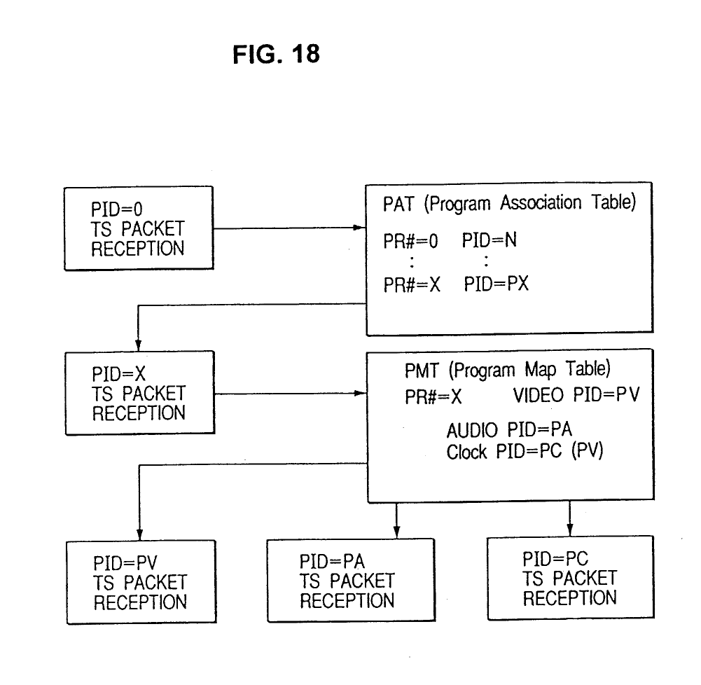

A description will be given in the following of the method whereby a receiving apparatus determines from the contents of the aforementioned auxiliary information, for a desired program, those of the received TS packets which contain the data of that program. Of that auxiliary information, the PSI (Program Specific Information) actually consist of a set of table, sometimes referred to as the “signalling tables”, which are conveyed in the aforementioned multiplexed sub packets. Referring to FIG. 18, firstly packets for which PID is equal to zero is searched for, within the TS data. Such packets convey a table referred to as the PAT (Program Association Table). The PAT relates respective numbers (program numbers, or PRs) which have been preassigned to each of the programs, to a corresponding set of PIDs (i.e., the respective PIDs of the set of PESs such as video PES, audio PES which constitute a program). In that way, the set of PIDs corresponding to the required PR are identified. Next, auxiliary information packets conveying a table referred to as the PMT (Program Map Table) are searched for. Respective PMTs are provided for each of the programs which are conveyed by the TS, and a PMT defines the data which are conveyed by each of the PESs of the corresponding program i.e., video, audio, etc. Thus for example, it might be found that the TS main packets which convey the video data of the program with PR 15 each have the PDI 21, the main packets which convey the audio data of that program each have the PDI 56, and so on.

When the TS packet PIDs for the required program have thus been obtained, these packets can be extracted from the TS data, converted to corresponding PS packets, and recorded, or be directly decoded and the payload contents reproduced.

An information system is thereby provided whereby it is possible to access (enter) the channel of any desired program, by utilizing the corresponding program number PR.

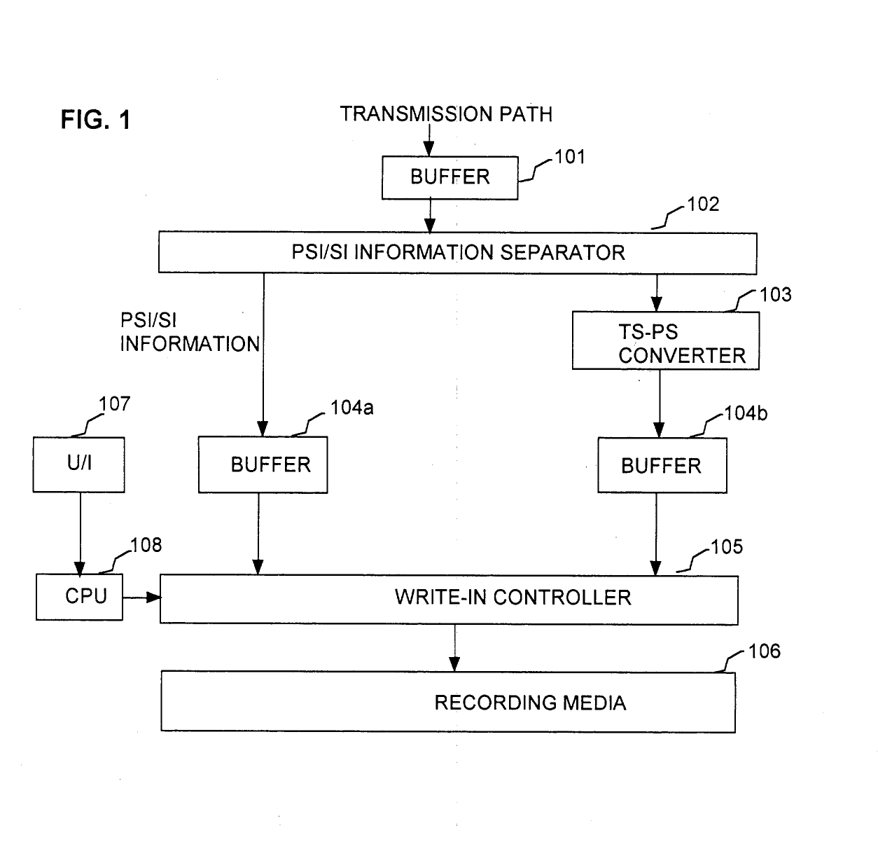

An embodiment of a recording apparatus according to the present invention will be described, referring to FIG. 1. Firstly, a received MPEG transport stream which has been transmitted via a broadcast or communications transmission path is buffered in a buffer 101. The data read out from the buffer 101 are subjected to separation of the PSI/SI auxiliary information by a PSI/SI information separator 102. In addition to the aforementioned PAT and PMT of the PSI, the auxiliary information also includes a SIT (Service Information Table), which conveys information relating to the service (e.g., broadcasting system, etc.) as a whole. The syntax will be described hereinafter. In the case of the PAT, the PID within the header is predetermined as being 0. The respective PIDs of the PMTs corresponding to the various programs are obtained from the PAT. The PID of the SIT is predetermined as being 1F. Thus, the respective PIDs for the packets which convey the PSI/SI information are all available to the recording apparatus. These PIDs are used to separate the PSI/SI information from the received MPEG transport stream, and the separated PSI/SI information is supplied to the buffer 104a.

Conversion of the MPEG transport stream data (i.e., other than the PSI/SI auxiliary information) is then performed by the TS-PS converter 103, to obtain each of the program streams which are conveyed by the TS. After decoding up to the PES layer has been performed (as described hereinafter), a program stream is formed into packs having a predetermined number of bytes. For example, if the data are to be recorded on an optical disk then the pack length is 2 KB, which is the sector length. A converted program stream is transferred into the buffer 104b.

The PSI/SI information and the program streams which are respectively outputted from the buffers 104a, 104b, are recorded on a recording medium 106 by a write-in controller 105, using specific file names. The recording file names are determined as follows. When the CPU 108 receives the program information number which is to be assigned to a program, from the user interface (U/I) 107, it supplies that information together with management information for managing the data (as described hereinafter) to the write-in controller 105, and designates that these are to be recorded (i.e., linked to the recorded data for the corresponding program).

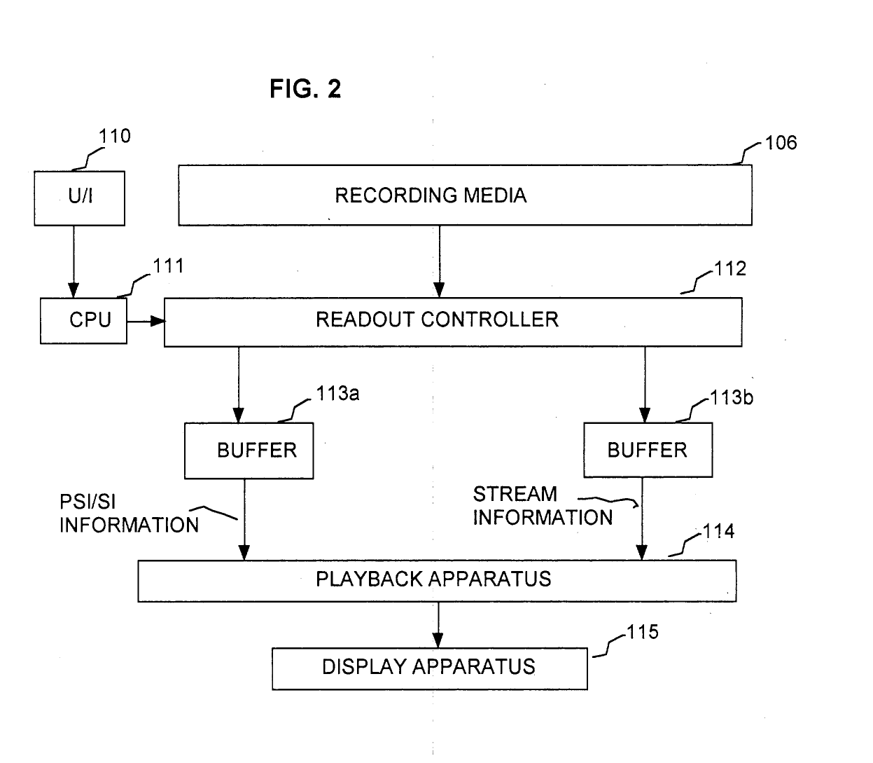

An embodiment of a playback apparatus according to the present invention, for playback of programs whose PS data are recorded as described above, will be described referring to FIG. 2. When a program information number is supplied from the user interface 110 to the CPU 111, the CPU 111 judges which program is to be reproduced, and outputs a command signal to the readout controller 112. This signal designates the name of the file which is to be read out, and the corresponding management information. The readout controller 112 responds by reading out the specified management information from the recording medium 6, and, if required, the management information is displayed to the user. In addition the readout controller 112 reads out the PSI/SI information relating to the specified program, and the video/audio multiplexed program stream, and transfers these to the buffers 113a, 113b respectively, to be supplied therefrom to the playback apparatus 114.

The playback apparatus demultiplexes the video and audio PESs, and converts these back to respective elementary streams of MPEG-compressed data, which are then decoded to recover the original video and audio data streams. These are supplied to a display device and loudspeaker, respectively (collective indicated as the display device 115 in FIG. 2).

In addition, the playback section 114 operates on the PSI/SI information supplied from the buffer 113a, to output to the display device 115 information relating to reproduction, which is contained in the PSI/SI information. Such information relating to reproduction might for example include the program title, etc., which is thereby supplied to the display device 115 to be displayed.

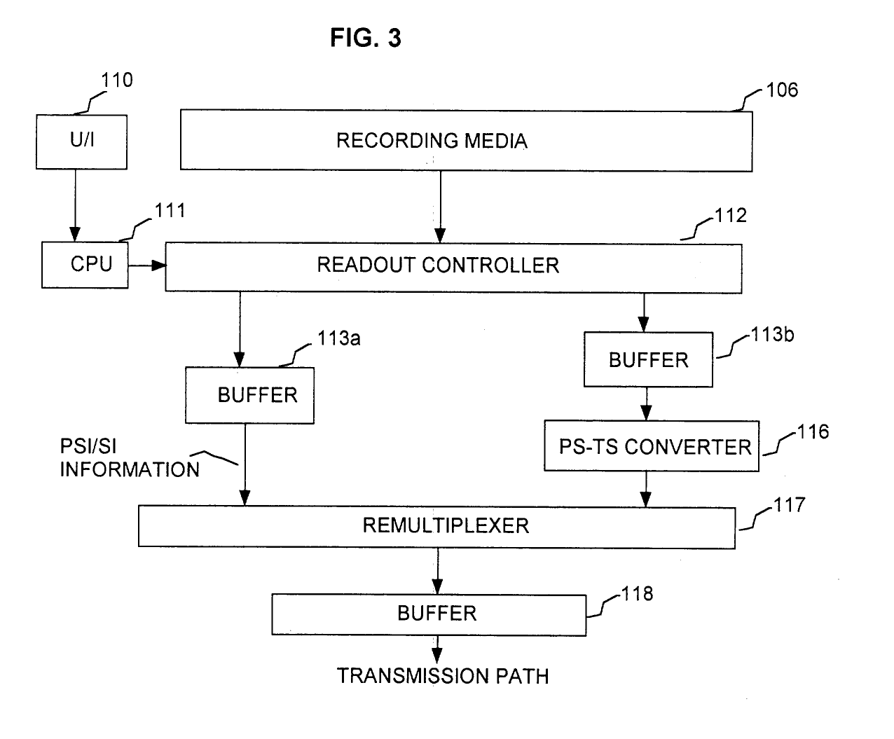

A preferred embodiment of a transmission apparatus according to the present invention will be described in the following, referring to FIG. 3. Assuming for simplicity of description that the data of a single program, previously recorded as PS data on the recording medium 106, is to be transmitted in an MPEG-2 TS, the operation is as follows. Firstly, the program information number specifying the required program is supplied from the user interface 110 to the CPU 111. The CPU 111 then identifies the files containing the program information which is to be read out from the recording medium 106 and transmitted, and sends a command signal to the readout controller 112 which designates readout of these files, together with associated management information. In response, the readout controller 112 reads out the required management information from the recording medium 106, and (if required) displays the management information the user by a display device (not shown in the drawings). In addition, the readout controller 112 reads out the requisite PSI/SI information, and the PS data of the required program. These are respectively transferred via the buffer 113a to the re-multiplexer 117, and via the buffer 113b to the PS-TS converter 116.

The PS data, i.e., with video and audio contents multiplexed therein in packet form as described hereinabove, is converted to an MPEG-2 transport stream by the PS-TS converter 116. The converted transport stream is supplied to the re-multiplexer 117, to be multiplexed with the PSI/SI information from the buffer 113a. That is to say, PAT/PMT/SIT packets etc., are multiplexed within the transport stream, spaced apart by specific time intervals. The resultant re-multiplexed transport stream is then transferred through the buffer 108, to be outputted from that buffer to a transmission path at a predetermined data rate.

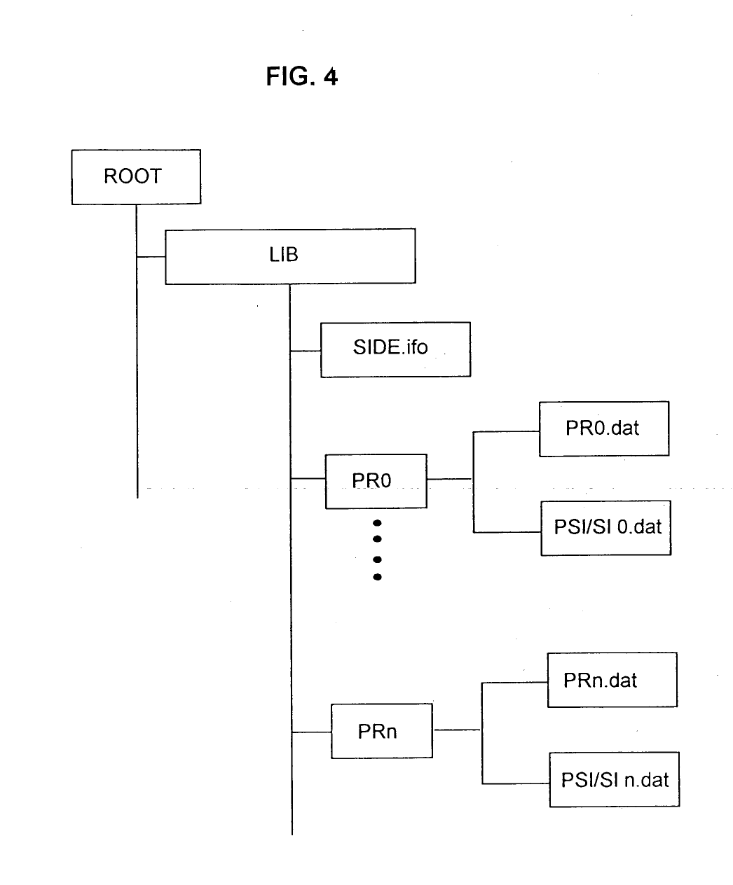

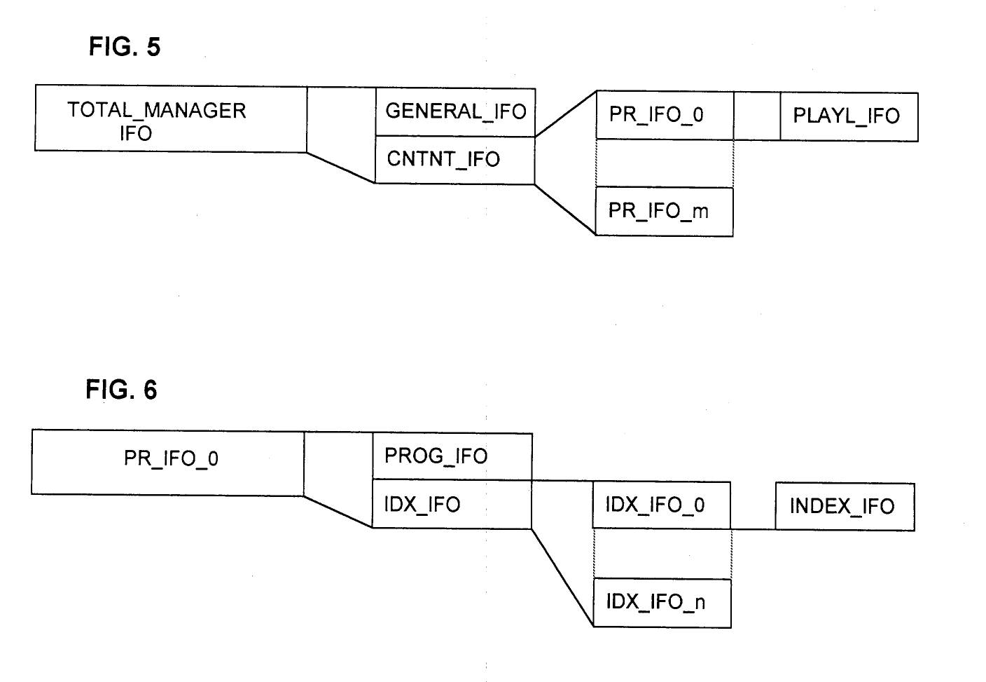

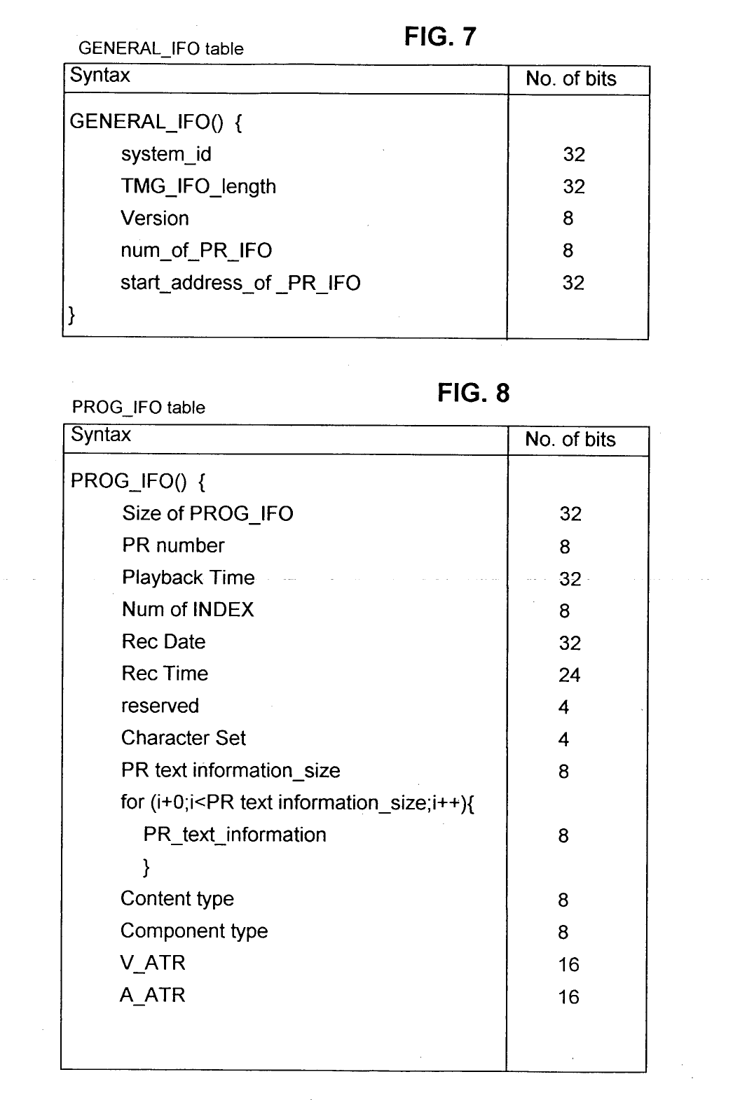

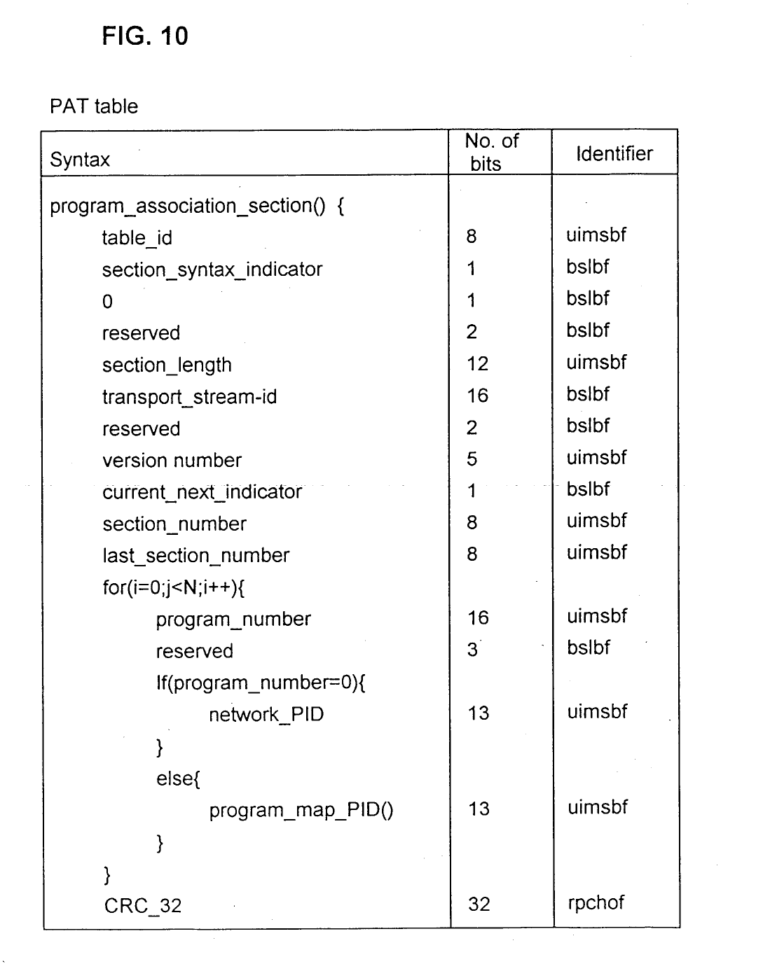

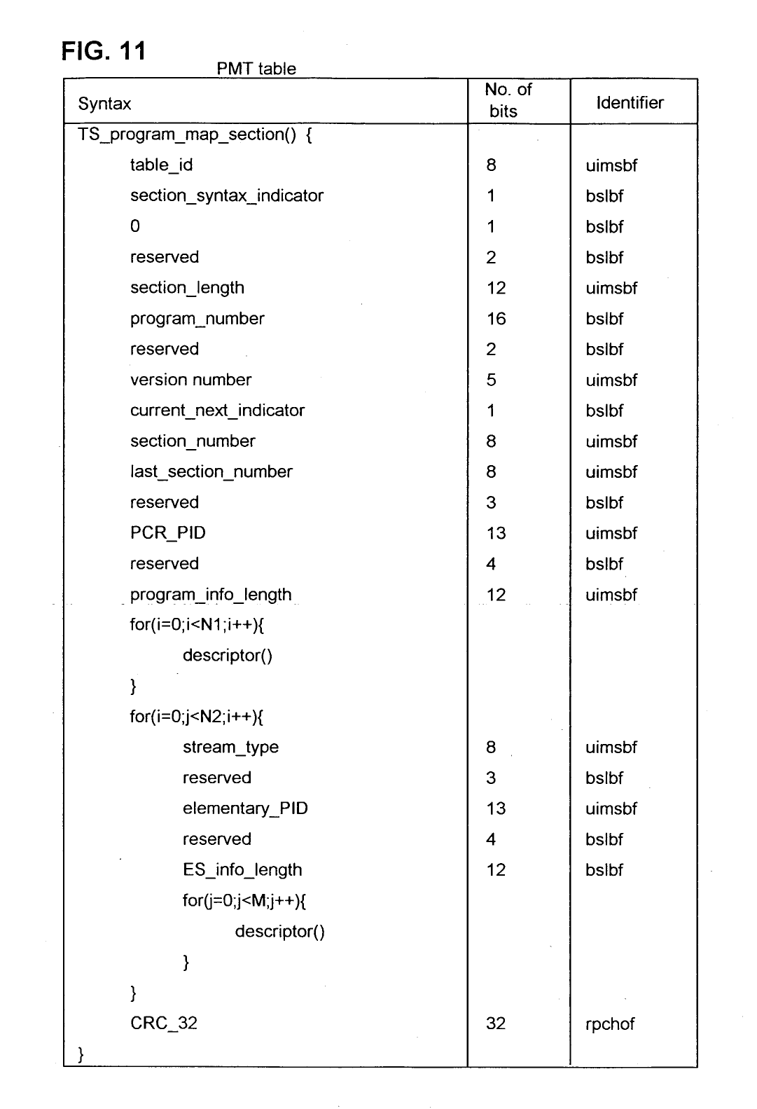

The format in which information is recorded on the recording medium 106 will be described referring to FIGS. 4 to 13. As shown in FIG. 4, the format is a directory hierarchy structure, with a folder named LIB being formed under ROOT, and with side information (i.e., information relating to a plurality of recorded programs), being recorded in a file which is named SIDE.ifo, under the LIB folder. The SIDE.ifo format, as shown in FIG. 5, is a hierarchy configuration. The information TOTAL_MANAGER_IFO is set at the highest position in the hierarchy, and includes GENERAL_IFO and CNTNT.IFO. GENERAL.IFO describes parameters relating to the overall recorded information. The syntax of GENERAL.IFO is shown in detail in FIG. 7.

The folder CNTNT.IFO contains respective sets of folders containing information for recorded programs, i.e., the folders designated respectively as PR_IFO_{—}0 to PR-IFO_n in FIG. 5. That is to say, these respectively correspond to the programs which have been recorded (in PS data form as described hereinabove) on the recording medium. Each of these folders PR_IFO_{—}0 to PR-IFO_n, as shown in FIG. 6, contains a table of information concerning the corresponding program, e.g., the PROG_IFO table indicated in FIG. 6, and a folder IDX_IFO, described hereinafter.

The syntax of the PROG_IFO table is as shown in FIG. 8.

As illustrated in FIG. 4, the PS data of a recorded program are linked to the PSI/SI data relating to that program stream by being contained in the same folder. For example, in the case of a program identified in FIG. 4 by the number 0, the folder PRO contains the recorded PS data of that program (stored in the file named PR0.data) and the associated PSI/SI information (stored in the file which is named PSI/SI0.data).

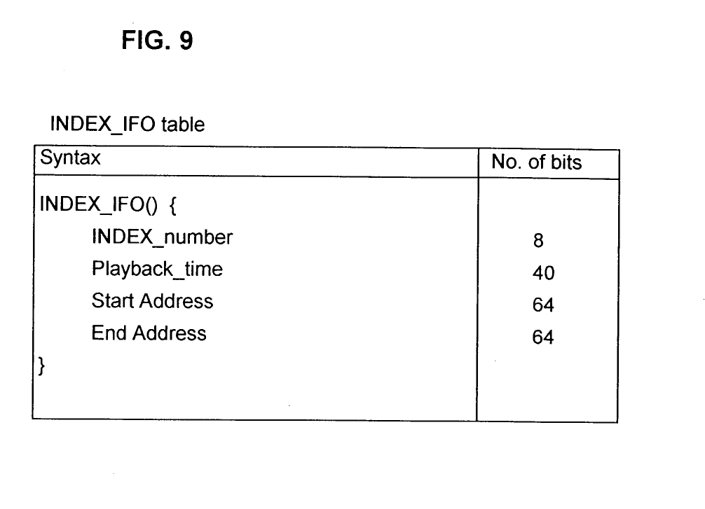

Referring again to the side information hierarchy, in the next-lower level of hierarchy (below the PR_IFO folders) the IDX.IFO folder contains information which can specify, for each of the recorded programs, indexed parts of the program. These are specified in respective INDEX.IFO tables. The format of IDX.IFO is as shown in FIG. 6, and the syntax of an INDEX.IFO table is as shown in FIG. 9.

The PAT, PMT and SIT information components of the PSI are each conveyed in the MPEG-2 transport stream as a sequence of three packets (i.e., each 188 bytes in length, for a total of 564 bytes). The PAT, PMT and SIT information sections are recorded consecutively on the recording medium.

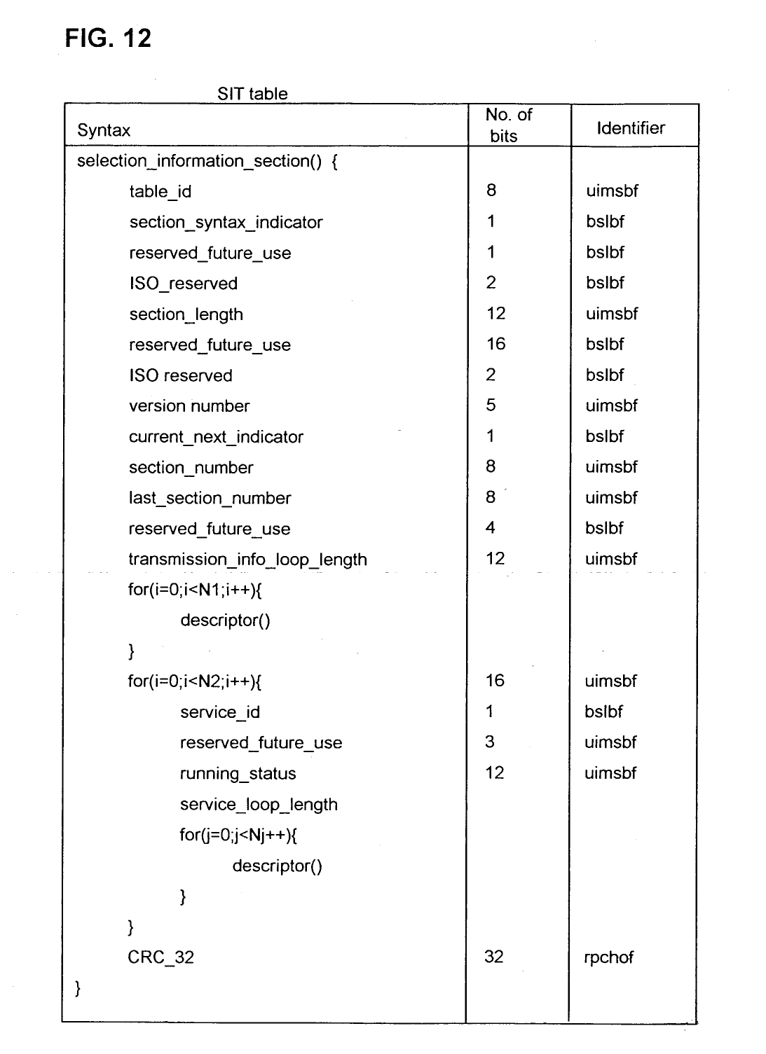

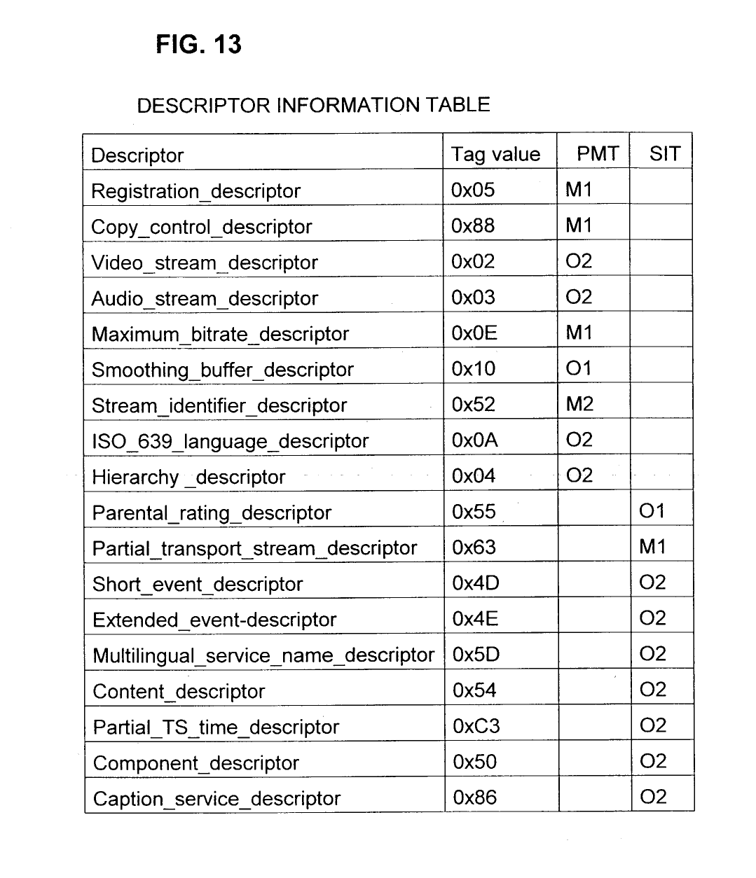

The SI (service information) includes information relating to the video and audio contents of a program. For example in the case of the D-VHS recording format, the SI information is contained in the SIT, i.e. Service Information Table (shown in FIG. 12) that is conveyed in the MPEG transport stream. Each PMT and SIT contains detailed information, referred to as descriptors. FIG. 13 shows a table of descriptors, for the case of the D-VHS format. The descriptors are recorded under the respective names shown in FIG. 13. Each descriptor has a marker assigned thereto, in the PMT column (in the case of items relating to a PMT) or the SIT column (in the case of items relating to the SIT) of the descriptor table, i.e., an “M” marker indicating that the descriptor is essential, or an “O” marker indicating that the descriptor is optional. The optional descriptors consist of information whose omission will not result in problems. However with this embodiment, it is assumed that all of the descriptors are used.

In the case of digital broadcasting standards such as the ARIB, DBV, ATSC, etc., the MPEG-2 multiplexing format enables various tables relating to broadcast programs and broadcasting conditions etc., i.e., user-defined Private_section tables, to be transmitted as packets in the MPEG transport stream. If required, the PSI/SI table contents conveyed in the MPEG-2 TS can be recorded as a continuous file, i.e., formed of a succession of TS packets (each having 188 bytes) arranged in a predetermined sequence.

In addition, in the case of a recording medium having data recorded thereon by means of an MPEG recording apparatus according to the present invention, the data are converted to the original TS data when they are read out from the recording medium to be transmitted. At that time, the invention enables these data to be re-multiplexed with PSI/SI information (read out from the recording medium) that is compatible with the overall transmission system and is appropriate for the program (or programs) which are to be transmitted.

It should be understood that the term “recording medium” is used in this description and in the appended claims with a broad significance, and is not restricted to any specific type of medium. It should also be noted that the term “recording” of data is not restricted to any particular method of recording or storing data.

As can be understood from the above, with the present invention, when an MPEG-2 transport stream (TS) is supplied to a recording apparatus, and is converted to respective MPEG program streams (PS) of one or more programs before being recorded on a recording medium, information constituting all or part of the program-specific information (PSI) and service information (SI) which are conveyed in multiplexed form together with the received TS are de-multiplexed and are recorded on the recording medium in such a manner that PSI/SI information relating to respective programs are recorded linked to the recorded PS data of these programs.

When the recorded PS data of a program are subsequently reproduced (i.e., playback of the PS from the recording medium is executed) and the output data are converted back to TS form, all or part of the contents of the PSI and SI that were recorded linked to that PS are re-multiplexed into the TS. The resultant TS can then be transmitted to a receiving apparatus which is designed to operate on MPEG-2 TS data.

The invention is for example applicable to the case of an MPEG-2 transport stream which is received from a digital broadcast or from a D-VHS source, etc., and is converted to an MPEG program stream in order to be then recorded on an optical disk or hard disk. In that case, when the data are subsequently reproduced from the disk, and sent to an apparatus which can reproduce an external transport stream, the original program specific information (PSI) and service information (SI) can be re-multiplexed into that transport stream. As a result, the invention enables a system to be realized which preserves convertibility in a very simple manner.

Furthermore when the PSI/SI information consists of PAT/PMT/SIT information, then after the TS data of a D-VHS stream has been converted to PS data, the PS data can subsequently be converted back to a TS stream having the PSI/SI information re-multiplexed therein. Convertibility is thereby maintained for the TS data, which can then be transmitted. Moreover if the SI consists of table information relating to service information which is prescribed by the ARIB, DVB or ATSC, then after TS data which have been digitally broadcast are converted to PS data, these can subsequently be converted to re-multiplexed TS data having convertibility, which can then be transmitted.

Moreover with the invention, information is recorded, on a recording medium, which expresses all or part of the program-specific information (PSI) and service information (SI) that were specified in the MPEG transport stream (TS) before that was converted to an MPEG program stream (PS), i.e., all or part of the PSI/SI information are recorded linked to the MPEG program stream. As a result, when the recorded data are reproduced (e.g., playback is performed) and the PS is converted back to the original TS, the PSI/SI information can be re-multiplexed together with TS into a data stream, which can then be transmitted. That is to say, a structured data stream having convertibility (as defined hereinabove) can be recovered and transmitted.

As can be understood from the above description, the present invention enables an MPEG transport stream to be converted to an MPEG program stream, which is recorded on a recording medium such as to be linked to information (also recorded on the recording medium) which specifies at least a part of program specific information and service information, with the program specific information and service information having been separated from the MPEG transport stream. As a result, for example in the case of MPEG transport stream data being received from a digital broadcast or from D-VHS, converted to MPEG program stream data and then recorded on an optical disk or hard disk and subsequently reproduced from the disk, the data which are thus reproduced can then be supplied to an apparatus which is capable of reproducing the original MPEG transport stream. Hence, a high degree of system convertibility is maintained.

What is claimed is:

1. An MPEG recording apparatus comprising
conversion means for converting an MPEG transport stream of data to an MPEG program stream of data,
separation means for separating from said MPEG transport stream all or part of information which is constituted by at least program specific information and service information which are contained in said MPEG transport stream, and
means for recording on a recording medium said converted MPEG program stream and said information which are separated from said MPEG transport stream, with said separated information being recorded linked to said converted MPEG program stream.

2. A recording medium having recorded thereon an MPEG program stream of data which has been converted from an MPEG transport stream of data, and separated information comprising all or part of information which is constituted by at least program specific information and service information which are contained in said MPEG transport stream, with said separated information being recorded on said recording medium such as to be linked to said converted MPEG program stream.

3. A playback apparatus for executing playback of a recording medium as claimed in claim 2, comprising
means for reading out from said recording medium said MPEG program stream and at least a part of said separated information, and
means for decoding the data of said MPEG program stream and combining resultant decoded data with said at least part of the separated data to produce outputted playback data.

4. A transmission apparatus for reading out and transmitting, via a transmission path, information recorded on a recording medium as claimed in claim 2, comprising
means for reading out from said recording medium said MPEG program stream and said information comprising all or part of said program specific information and service information,
conversion means for converting said MPEG program stream read out from said recording medium to an MPEG transport stream, and
means for re-multiplexing said converted MPEG transport stream with said information comprising all or part of said program specific information and service information, to thereby obtain a re-multiplexed data stream, and for transmitting said re-multiplexed data stream.

5. An MPEG recording method comprising
converting an MPEG transport stream of data to an MPEG program stream of data,
separating from said MPEG transport stream all or part of information which is constituted by at least program specific information and service information which are contained in said MPEG transport stream, and
recording on a recording medium said converted MPEG program stream and said information which are separated from said MPEG transport stream, with said separated information being recorded linked to said converted MPEG program stream.

6. A method of executing playback of a recording medium as claimed in claim 2, comprising
reading out from said recording medium said MPEG program stream and at least a part of said separated information, and
decoding the data of said MPEG program stream and combining resultant decoded data with said at least part of the separated data to produce outputted playback data.

7. A method of reading out and transmitting, via a transmission path, information recorded on a recording medium as claimed in claim 2, comprising
reading out from said recording medium said MPEG program stream and said information comprising all or part of said program specific information and service information,
converting said MPEG program stream read out from said recording medium to an MPEG transport stream, and
re-multiplexing said converted MPEG transport stream with said information comprising all or part of said program specific information and service information, to thereby obtain a re-multiplexed data stream, and transmitting said re-multiplexed data stream.
